(19) United States
(12) Patent Application Publication
(10) Pub. No.: US 2004/0140157 A1
(43) Pub. Date: Jul. 22, 2004

(54) Integrated tree stand and blind system

(76) Inventor: John Undi, Surrey (CA)

Correspondence Address: McCarthy Tetrault, Box 48, Suite 4700, 66 Wellington St. W., Toronto, ON, M5K 1E6, CA

(21) Appl. No.: 10/347,371

(22) Filed: Jan. 21, 2003

(51) Int. Cl. A01M 31/00

(52) U.S. Cl. 182/187

(57) ABSTRACT

A tree stand for use at an elevated position on a tree trunk and adapted to support a tent or other complete covering. The stand comprises a generally horizontal platform for providing a floor of the tent. A first support is connected to the platform and adapted for securing releasably a proximal end of the platform at a fixed first position on the tree trunk. the support has spikes and a racheting mechanism to help anchor the stand to the tree. A cross-member has a second support and is adapted for securing releasably the cross-member at a second fixed position on the tree trunk higher than the first position.

The stand also has a pair of proximal tensioning members for connecting the cross-member to either side of a proximal end of the platform, and a pair of distal tensioning members for connecting the cross-member to either side of a distal end of the platform. When used, the tree stand operates such that the tensioning members and platform form a generally triangular prism.

### BACKGROUND OF THE INVENTION

1. Field of the Invention

The present invention relates to a tree stand and more particularly to an integrated tree stand and blind system.

2. Description of the Prior Art

The sport of hunting large animals requires a hunting blind or tree stand for helping to conceal a hunter's presence in the animals' general vicinity. Stands are typically situated above ground attached to a tree, primarily used for large game hunting. Blinds are typically situated on the ground, primarily used in fowl hunting, and employ a tent or other partial covering attached to a blind structure. Tree stands can take various forms, usually suspended in trees. Tree stands are used to improve the hunter's overview of the surroundings, as well as helping to prevent injury to the hunter from direct contact with neighbouring animals. Tree stands generally consist of a platform with supporting structure for securing the platform in a fixed horizontal orientation and height above the ground.

One disadvantage of tree stands, such as in U.S. Pat. No. 4,782,918, is that the hunter is exposed to inclement weather. One solution is to attach a cover to the tree stand. However, disadvantages with current tree stand and cover arrangements are that their structures typically require many structural elements, and therefore can be heavy and awkward to assemble and then lift into the tree. Examples of these complex structured stand and cover arrangements can be found in U.S. Pat. Nos. 5,218,982 and 6,053,190. A further disadvantage is that the tree stands employ structural members to support both the front and rear portions of the platform, thus adding to the weight of the stand structure, such as shown in U.S. Pat. No. 4,782,918. Further, typically stands gain extra weight when structural members are added in order to attach a complete covering, otherwise most lighter stands use a roof only.

Another disadvantage of the current tree stand and cover arrangements is that once the stand structure is assembled and fastened up in the tree, the hunter must then climb up on the platform, assemble the cover separately, and attach it to the structure at an elevated height. The erection of the cover in this manner can be dangerous due to the typically small platform size, as well as the absence of adequate railings or other guards on the structure.

It is an object of the present invention to provide an integrated tree stand and blind system to obviate or mitigate at least some of the above-presented disadvantages.

### SUMMARY OF THE INVENTION

Accordingly, to the present invention there is provided a tree stand for use at an elevated position on a tree trunk and adapted to support a tent. The stand comprises, a platform for providing a floor of the tent; a first support connected to the platform and adapted for securing releasably a proximal end of the platform at a fixed first position on the tree trunk; a cross-member having a second support, the second support adapted for securing releasably the cross-member at a second fixed position on the tree trunk higher than the first position; a pair of proximal tensioning members for connecting the cross-member to either side of a proximal end of the platform; and a pair of distal tensioning members for connecting the cross-member to either side of a distal end of the platform; wherein when erected, the tensioning members and platform for a generally triangular prism.

### BRIEF DESCRIPTION OF THE DRAWINGS

These and other features of the preferred embodiments of the invention will become more apparent in the following detailed description in which reference is made to the appended drawings by way of example only, wherein:

FIG. 1 is a perspective view of a support structure of a tree tent;

FIG. 2 is a perspective view of the structure of FIG. 1 with a tent attached;

FIG. 3 is a top perspective view of a platform frame of FIG. 1;

FIG. 4 is a further view of an end member of the frame of FIG. 3;

FIG. 5 is a partially assembled view of the platform of FIG. 1;

FIG. 6 is a top perspective view of the platform of FIG. 1;

FIG. 7 is a further view of a cross member of the structure of FIG. 1; and

FIG. 8 is a further perspective view of a support of FIG. 1.

### DESCRIPTION OF THE PREFERRED EMBODIMENTS

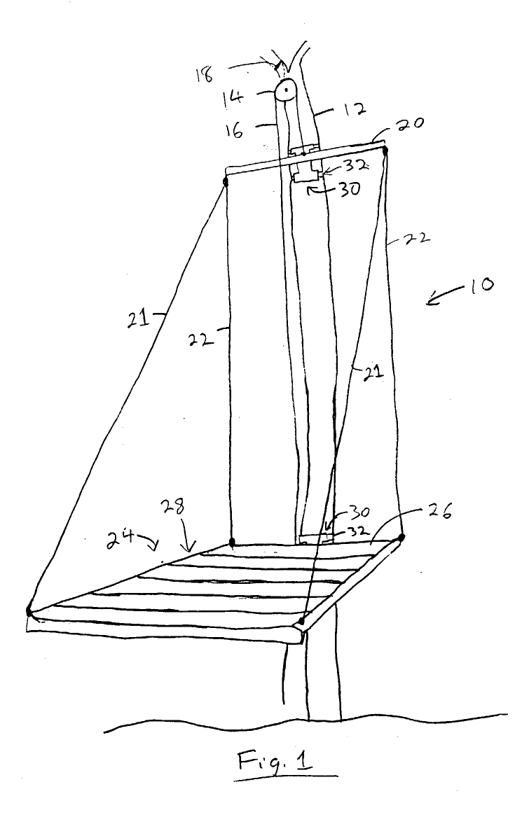

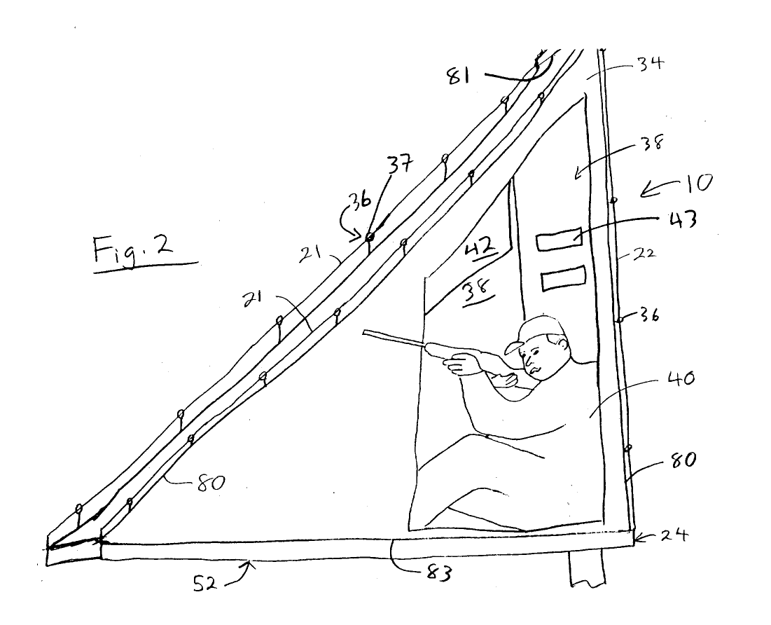

Referring to FIG. 1, an integrated tree tent structure 10 (tent omitted for clarity) is raised into position on a tree 12 by a raising mechanism such as but not limited to a pulley 14 and an associated rope 16 or a solitary length of the rope 16. The pulley 14 is attached to the tree 12 by a cable 18 and the rope 16 is attached at one end to a horizontal cross member 20 of the tree tent structure 10. The structure 10 also includes four cables 21, 22 connected at one end to either side of the cross member 20 and connected at the other end to respective corners of a platform 24. This configuration of the cables 21, 22 forms the vertical edges of a substantially right angled prism, such that the platform 24 forms a base and the cross member 20 forms an apex of the prism. It is recognised that the prism can consist of other triangle types and that the cables 21, 22 could be attached adjacent to the platform 24 corners, if desired. The platform 24 comprises a series of slats 26 to form a floor 28, capable of supporting at least one person when situated on the platform 24. A pair of supports 30 connect the structure 10 to the trunk of the tree 12, one of the supports 30 is connected to the cross member 20 and the other of the supports 30 is connected to a proximal end of the platform 24, as further explained below. The supports 30 are fastened to the tree 12 by a series of belt and ratchet mechanisms 32. Accordingly, the platform 24 of the structure 10 can be secured releasably to the tree 12 by means of the supports 30 and associated cross member 20 and cables 21, 22. It should be noted that cables 22 can provide support for erecting a tent 34 (see FIG. 2) and preferably do not provide support for the weight of the platform 24, which is accomplished by means of the supports 30, the tree 12 trunk between the supports 30, and the cables 21.

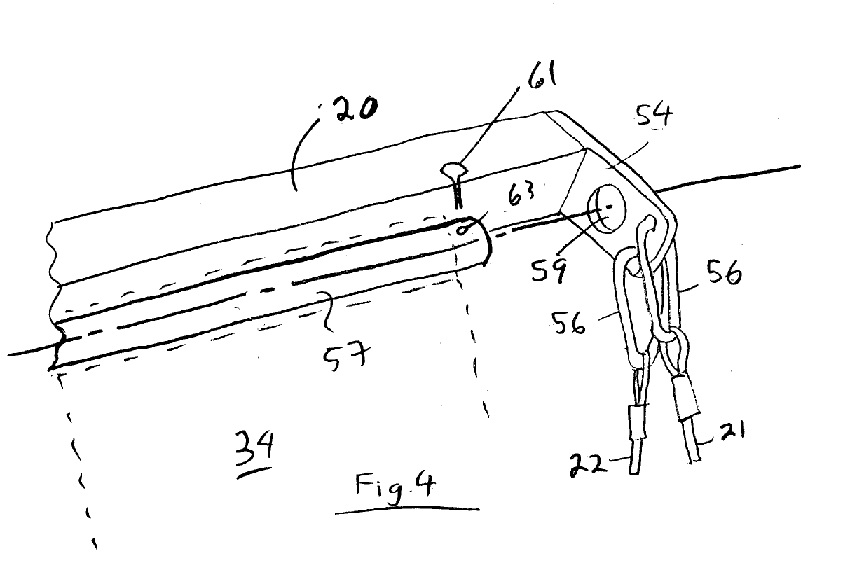

Referring to FIG. 2, the structure 10 is shown with the tent 34 attached. The tent 34 is supported on the structure 10 through multiple pairs of fabric straps 36, which can be connected at one end to the tent corners 80 and are wrapped around the cables 21, 22 at the other end of the straps 36 by loops 37. For example, the straps 36 can use, such as but not limited to, Velcro™ to help form and secure releasably the loop 37 around the cable 21, 22. Other types of connections of the tent 34 to the cables 21, 22 can include such as but not limited to ring connectors and sleeves situated along the corners 80 of the tent 34. Referring to FIG. 4, the top of the tent 34 is connected releasably to the cross member 20 by means of a metal rod 57 (see FIG. 4) inserted through a tent sleeve (not shown) situated along corner 81 (see FIG. 2). The bottom 83 of the tent 34 can be secured releasably to the platform 24 by means of Velcro™ strips. Other forms of attachment can include such as but not limited to ties, snaps, and other fasteners as is known in the art. The tent 34 has windows 38 at the sides of the tent 34 for access by a hunter 40. Flaps 42 can close the windows 38, for enclosing the tent 34 in situations such as inclement weather and/or sleeping by the hunter 40. Once enclosed, if desired, the hunter 40 can rest inside the tent 34 on the platform 24. The tent 34 also can have pockets 43 attached to the interior for storing the hunter's belongings.

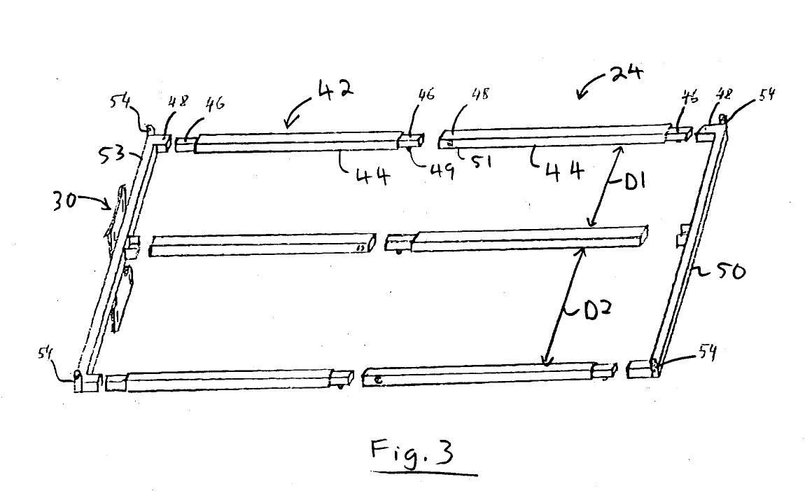

Referring to FIG. 3, the platform 24 (slats 26 omitted for clarity) has a frame 42, comprising structural members 44, such as but not limited to metal tubes, that can connect at either end by complementary male 46 and female 48 connectors. The structural members 44 are preferably composed in sections to help facilitate portability of the disassembled platform 24. The assembled male 46 and female 48 connectors are secured releasably by fasteners as is known in the art, such as but not limited to complementary pin 49 and hole 51 arrangements. The frame 42 also has end members 50, 53 having connectors 46, 48, that position the members 44 at predefined distances along the length of the end members 50, 53. For example, distance D1 can be less than distance D2 to provide adequate access to the hunter 40, when entering through the platform 24 from the underside 52 (see FIG. 2). Further, it should be noted that the end member 53 is connected to the support 30. For example, end member 53 is similar in form to cross member 20 with the attached support 30, such that the members 20 and 53 with attached supports 30 anchor the top and bottom of the stand 10 to the tree 12. The members 20, 53 and associated supports 30 allow the tree 12 trunk to act as a proximal structural component of the stand 10.

Referring to FIG. 4, the cross member 20 can have the cables 21, 22 attached to a flange 54, for example by clips 56. Further, the metal rod 57 is inserted into the sleeve of the tent 34, shown in ghosted view, prior to the rod 57 being inserted into a hole 59 of the flange 54. For example, cotter pins 61 are inserted into corresponding holes 63, on either side of the rod 57, which can be used to secure the rod 57 and attached tent 34 to the cross-member 20. Further, the rod 57 could also be attached at either end to the cross member 20 by such as but not limited to hooks or any other appropriate mechanism as is known in the art.

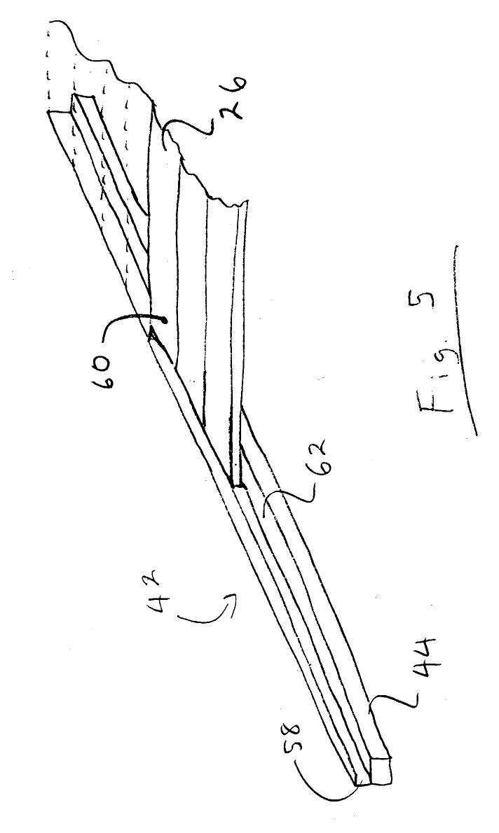

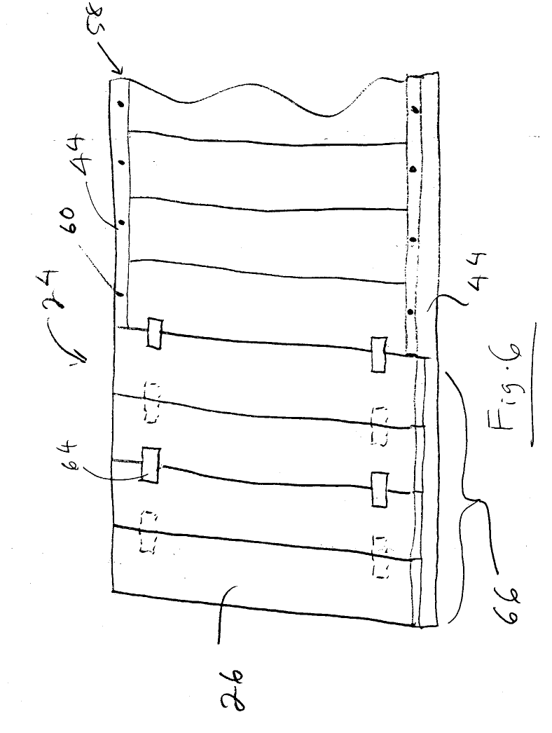

Referring to FIG. 5, outside ones of the members 44 have a channel 58 for receiving the slats 26. A Pin 60 is used to secure the last slat 26 in the channel 58 through aligned holes (not shown) in the slat 26 and members 44, thereby securing all slats 26 resident in the channel 58. The last four (such as but not limited to) slats 26 (shown in ghosted view) may not be contained within the channel 58, rather may be free to rest unconstrained on the upper surface 62 of the member 44. Referring to FIG. 6, the unconstrained slats 26 (forming a section 66) can have attached straps 64 providing hinge members, in order to couple adjacent slats 26 to one another. Further, the straps 64, for example such as but not limited to elastic material strips, can be placed alternating on the upper and lower surfaces of the slats 26, such that the unconstrained section 66 can open in an accordion fashion. It is recognised that the unconstrained section 66 may also contain decoupled slats 26, if desired. Further, the slats 26 may be made of wood or another material with insulating properties.

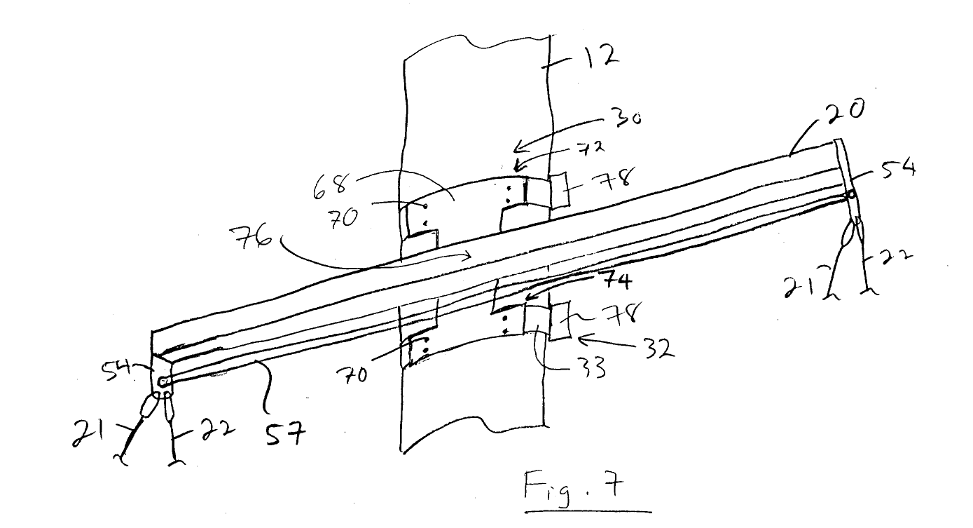

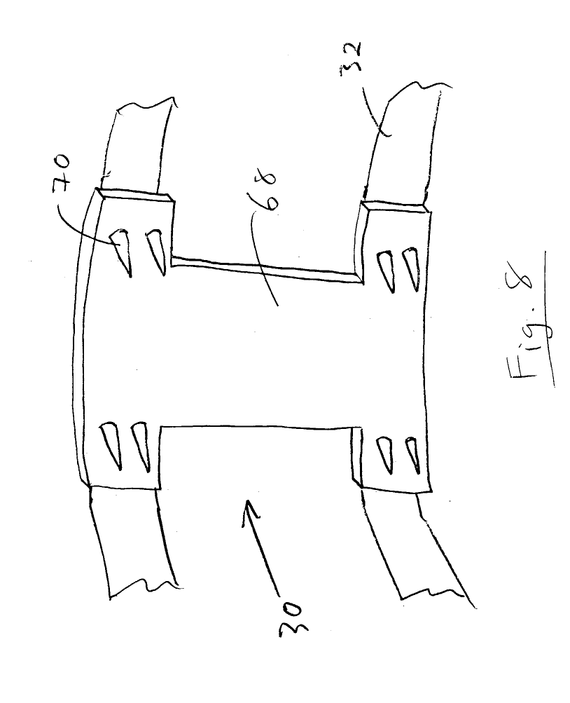

Referring to FIG. 7, the support 30 has attached belts 33 for wrapping around the trunk of the tree 12. The body 68 of the support 30 can be curved to help accommodate the curvature of the trunk. The body 68 also has spikes 70 or other tapered projections positioned in pairs, one at a top 72 and one at a bottom 74 of the support 30. The spikes 70 are to help the cross member 20 grip the tree 12 and to help stop the cross member 20 from rotating about a centre of gravity 76, when unequal tension forces are applied to the cables 21, 22. Further, the support 30 has a ratchet 78 attached to each belt 33 to assist in tightening of the belt 33, by the hunter 40, around the tree 12. Operation of the ratchet 78 is as known in the art. It is considered that the support 30 on the platform 24 can have a similar configuration to that of the support 30 attached to the cross member 20. Further, only one belt 33 (not shown) can also be used attach the body 68 of the support 30 to the tree 12, if desired. Referring to FIG. 8, the spikes 70 are oriented to project into the tree (not shown) when the belts 32 are tightened.

In operation, referring to FIG. 3, the members 44 and the end members 50 are assembled by use of the connectors 46, 48 and appropriate fasteners to construct the frame 42. Referring to FIG. 5, the slats 26 received by the channel 58, with the last slat 26 in the channel 58 attached using the pins 60 to the top surface 62 of the members 44. The section 66 (see FIG. 6) remains unattached to the frame 42, in order to allow access of the hunter 40 to the platform 24 once the structure is raised into the tree 12 (see FIG. 1). Referring to FIG. 2, the straps 36 of the tent 34 are connected to the cables 21, 22, which are then subsequently attached to the four corners of the assembled platform 24 at the proximal/distal ends and to each end of the cross member 20. At this point, it should be noted that the tent 34 is collapsed and the platform 24 is on the ground.

Referring to FIG. 1, the hunter 40 (see FIG. 2) then attaches the pulley 14 by means of the cable 18 to the tree 12, and then proceeds to raise the cross member 20 by pulling on the rope 16. At a certain height, the cross member 20 is raised such that the cables 21, 22 begin to support the weight of the platform 24, which is still resting on the ground. At this point, since the tent 34 is attached to the platform 24 and the cross member 20, the tent 34 will now be completely erected in a triangular shape (see FIG. 2) which corresponds to the shape of the structure 10. The four corners 80 of the tent 34 are now supported by the cables 21, 22, such that the tent 34 now mimics the rectangular prism shape of the structure 10. It should be noted that the tent 34 has been erected automatically as the prism shape of the structure 10 has formed. Further raising of the cross member 20, by pulling on the rope 16, causes the combination erected tent 34 and structure 10 to be placed into the upper reaches of the tree 12. The hunter 40 then secures the rope 16 such that the height of the tent 34 and structure 10 remains stable. The hunter 40 then climbs up to the platform 24 (such as by use of a ladder) and then ratchets the supports 30 to the tree 12, as described below.

The hunter 40 then proceeds to wrap the belts 33, see FIGS. 7 and 1, around the tree 12 and then tightens the ratchet 78, such that the spikes 70 are embedded into the trunk. The tightening of the belts 33 is done at both the supports 30 attached to the cross member 20 and the platform 24. In this configuration, the tree 12 trunk now supports the weight of the platform 24 between the upper and lower supports 30, hence cables 22 may not be required for supporting the dead weight of the platform 24. Further, the cables 21 now support the front portion of the platform 24, as they are now coupled to the tree 12 through the cross member 20. It is noted that cables 22 can provide some torsional rigidity to the structure 10 about the tree 12 trunk.

At this point the platform 24 and integrated tent 34 is assembled and ready for use. The hunter 40 can then enter the erected tent 34 through the accordion section 66. Once inside the tent 34, the accordion section 66 is placed in a flat orientation, thereby forming the finished floor 28. Otherwise, the hunter 40 can enter the tent 34 through the windows 38.

Although the invention has been described with reference to certain specific embodiments, various modifications thereof will be apparent to those skilled in the art without departing from the spirit and scope of the invention as outlined in the claims appended hereto. For example, telescopic poles or other such devices could be used instead of the cables 21, 22, such that the poles/devices are capable of resisting appropriate tension forces generated by the weight of the platform 24, tent 34, and occupants. Further, it is recognised that the structure 10 could be erected and used by the hunter 40 independently of the tent 34.

The embodiments of the invention in which an exclusive property or privilege is claimed are defined as follows:

1. A tree stand for use at an elevated position on a tree trunk and adapted to support a tent, the stand comprising:
a) a platform for providing a floor of the tent;
b) a first support connected to the platform and adapted for securing releasably a proximal end of the platform at a fixed first position on the tree trunk;
c) a cross-member having a second support, the second support adapted for securing releasably the cross-member at a second fixed position on the tree trunk higher than the first position;
d) a pair of proximal tensioning members for connecting the cross-member to either side of a proximal end of the platform; and
e) a pair of distal tensioning members for connecting the cross-member to either side of a distal end of the platform;
wherein when erected, the tensioning members and platform form a generally triangular prism.

2. The stand of claim 1 further comprising the tent connectable to the tensioning members prior to erection of the stand.

3. The stand of claim 2 further comprising a plurality of straps for connecting releasably the tent to the tensioning members.

4. The stand of claim 3, wherein the straps are connected at one end to the tent and are adapted at the other end to a form loop about the tensioning members.

5. The stand of claim 4, wherein the straps have Velcro™ for forming the loops.

6. The stand of claim 3 wherein the straps are connected at one end to the tent and have a ring connector at the other end for connecting to the tensioning members.

7. The stand of claim 2 further comprising a top connector for connecting the tent to the cross-member.

8. The stand of claim 7; wherein the connector is a rod receivable within a sleeve located at the top of the tent.

9. The stand of claim 7 further comprising a bottom connector for connecting the tent to the sides of the platform.

10. The stand of claim 1 further comprising a raising mechanism connectable to the cross-member by a cable, the raising mechanism for attaching to the tree at the elevated position and for raising the erected stand to the elevated position.

11. The stand of claim 10 further comprising the tent connectable to the tensioning members prior to erection of the stand.

12. The stand of claim 11 further comprising a plurality of straps for connecting releasably the tent to the tensioning members.

13. The stand of claim 11, wherein once connected the tent and the stand are operable as an integrated structure, whereby the tent becomes simultaneously erected with the stand once the tensioning members become taut.

14. The stand of claim 1, wherein the platform further comprises a series of inter-connectable structural members for forming a frame and a plurality of slats for forming a floor on the frame.

15. The stand of claim 14 further comprising a section of the slats at one end of the floor, each of the slats of the section connected to adjacent ones by hinge members.

16. The stand of claim 1, wherein at least one of the supports further comprises a set of tapered projections for engaging the surface of the tree trunk, the projections positioned at a top and at a bottom of the support.

17. The stand of claim 16, wherein the supports further comprise a series of straps for tightening releasably the supports about the tree trunk.

18. The stand of claim 17, wherein the supports have a ratchet as a tightening mechanism.

19. The stand of claim 17, wherein a first set of straps is located at the top and a second set of straps is located at the bottom of the supports.

20. The stand of claim 16, wherein the set of tapered projections includes a first pair of projections spaced apart on opposing sides at the top of the support and a second pair of projections spaced apart on opposing sides at the bottom of the support.

21. The stand of claim 20, wherein the support is I-shaped.

22. The stand of claim 20, wherein an inwardly directed face of the support is arcuate for accommodating the curvature of the tree trunk.

23. The stand of claim 1, wherein the weight of the platform is supported at the distal end by the distal tensioning members and at the proximal end by the first support.

24. The stand of claim 23, wherein the proximal tensioning members provide torsional rigidity of the stand about the tree trunk.

25. The stand of claim 15, wherein the hinge members are situated alternatingly on either side of the floor for providing an accordion operation of the section.
